(19) United States
(12) Patent Application Publication
(10) Pub. No.: US 2012/0017064 A1
(43) Pub. Date: Jan. 19, 2012

(54) INFORMATION PROCESSING APPARATUS, INFORMATION PROCESSING METHOD, AND PROGRAM

(75) Inventor: Yasuki Sasaki, Tokyo (JP)

(73) Assignee: SONY CORPORATION, Tokyo (JP)

(21) Appl. No.: 13/177,951

(22) Filed: Jul. 7, 2011

(30) Foreign Application Priority Data
Jul. 16, 2010 (JP) P2010-161190

(51) Int. Cl. G06F 12/10

(52) U.S. Cl. 711/206; 711/203; 711/E12.058; 711/E12.059

(57) ABSTRACT

An information processing apparatus is disclosed which is connected to a network and which includes: an address translation section configured such that when a virtual address assigned to a virtual storage area is held in an address translation module and associated therein with network node information designating the location of a storage portion connected to the network and with a physical address in the storage portion, the address translation section translates the virtual address into the network node information and the physical address based on the address translation module; and an access communication section configured such that based on the network node information and the physical address acquired by the address translation section, the access communication section accesses one of a plurality of storage areas held by the storage portion connected to the network, the accessed storage area being designated by the physical address.

### BACKGROUND OF THE INVENTION

The present disclosure relates to an information processing apparatus, an information processing method, and a program. More particularly, the disclosure relates to an information processing apparatus, an information processing method, and a program for utilizing memories, storages, or other recording media connected to networks as virtual storage areas.

There exist methods for expanding the memory area of a computer through the use of a virtual storage area. The virtual storage area is a memory area allocated or provided virtually by the operating system (OS) or the like of the computer. For example, if the memory capacity needed by the executing program turns out to be larger than the capacity of the actually incorporated memory, then the OS or the like of the computer may have to utilize the storage area of the memory or storage in use as the memory capacity required by the executing program. In that case, the storage area of the memory or storage is set up as a virtual storage area.

More specifically, there may be first established virtual addresses in the virtual storage area. The virtual addresses may then be translated into physical addresses of the storage area on the recording medium actually incorporated in the computer. Data may be read and written using the physical addresses (e.g., see Japanese Patent Laid-Open No. Hei 8-272754).

### SUMMARY OF THE INVENTION

With ordinary computers, the storage area of the memory or storage attached to each computer may be utilized thereby as the virtual storage area. However, these computers are incapable of using as their virtual storage area the storage areas on the hard disks or the like in servers connected to each computer via the network.

The present disclosure has been made in view of the above circumstances and provides an information processing apparatus, an information processing method, and a program for utilizing recording media connected to the network as a virtual storage area so that the currently executing program using virtual addresses may gain easy access to the storage areas on the recording media connected to the network.

According to one embodiment of the present disclosure, there is provided an information processing apparatus connected to a network, the information processing apparatus including: an address translation section configured such that when a virtual address assigned to a virtual storage area is held in an address translation module and associated therein with network node information designating the location of a storage portion connected to the network and with a physical address in the storage portion, the address translation section translates the virtual address into the network node information and the physical address based on the address translation module; and an access communication section configured such that based on the network node information and the physical address acquired by the address translation section, the access communication section accesses one of a plurality of storage areas held by the storage portion connected to the network, the accessed storage area being designated by the physical address.

Preferably, the information processing apparatus may further include a storage section having a plurality of storage areas; wherein, if the network node information acquired by the address translation section represents the location of the storage section connected to the network, then the access communication section may access one of the plurality of storage areas held by the storage section, the accessed storage area being designated by the physical address acquired by the address translation section; and if the network node information acquired by the address translation section represents the location of an external storage portion different from the storage section on the network, then the access communication section may access one of a plurality of storage areas held by the external storage portion, the accessed storage area being designated by the physical address acquired by the address translation section.

Preferably, the address translation module may hold a plurality of address translation tables each associating the virtual address with the network node information and the physical address; and based on the plurality of address translation tables held by the address translation module, the address translation module may translate the virtual address into the corresponding physical address and the corresponding network node information.

Preferably, the address translation module may hold an address translation table associating the virtual address with the network node information and the physical address; and the information processing apparatus may further include an update section configured to update the address translation table held by the address translation module.

Preferably, the network node information may be a part or all of an Internet Protocol address known as an IP address, a Media Access Control address known as a MAC address, or domain information.

Preferably, the address translation module may hold an address translation table associating the virtual address with the network node information and the physical address; and the information processing apparatus may further include a transmission section configured to transmit the address translation table held by the address translation module to another information processing apparatus connected to the network so as to share the address translation table with the other information processing apparatus.

According to another embodiment of the present disclosure, there is provided an information processing method for use with and information processing apparatus connected to a network and including an address translation section and an access communication section, the information processing method including: when a virtual address assigned to a virtual storage area is held in an address translation module and associated therein with network node information designating the location of a storage portion connected to the network and with a physical address in the storage portion, causing the address translation section to translate the virtual address into the network node information and the physical address based on the address translation module; and based on the network node information and the physical address acquired by the address translation section, causing the access communication section to access one of a plurality of storage areas held by the storage portion connected to the network, the accessed storage area being designated by the physical address.

According to a further embodiment of the present disclosure, there is provided a program for causing a computer controlling an information processing apparatus connected to a network to function as an address translation section and an access communication section, the program including: when a virtual address assigned to a virtual storage area is held in an address translation module and associated therein with network node information designating the location of a storage portion connected to the network and with a physical address in the storage portion, causing the address translation section to translate the virtual address into the network node information and the physical address based on the address translation module; and based on the network node information and the physical address acquired by the address translation section, causing the access communication section to access one of a plurality of storage areas held by the storage portion connected to the network, the accessed storage area being designated by the physical address.

According to the present disclosure, as outlined above, when a virtual address assigned to a virtual storage area is held in an address translation module and associated therein with network node information designating the location of a storage portion connected to the network and with a physical address in the storage portion, the virtual address is translated into the network node information and the physical address based on the address translation module. Then based on the network node information and the physical address acquired through address translation, one of a plurality of storage areas held by the storage portion connected to the network is accessed, the accessed storage area being designated by the physical address.

Thus according to the present disclosure, the recording media including memory or storage connected to the network can be utilized easily as virtual storage areas.

### BRIEF DESCRIPTION OF THE DRAWINGS

FIG. 1 is a block diagram showing a typical configuration of an information processing system embodying the present disclosure;

FIG. 2 is a block diagram showing a typical structure of an information processing apparatus;

FIG. 3 is a block diagram showing a detailed structure of a processor;

FIG. 4 is a schematic view showing an example of a plurality of entries furnished where a translation look-aside buffer (TLB) is used in conjunction with a memory management unit (MMU);

FIG. 5 is a schematic view showing a typical entry furnished where an address translation register is used in conjunction with MMU;

FIG. 6 is a schematic view showing an example of write information;

FIG. 7 is a schematic view explanatory of how write data is written under control of a DMA controller;

FIG. 8 is a schematic view showing another example of write information;

FIG. 9 is a schematic view showing an example of request information;

FIG. 10 is a schematic view showing an example of readout information created in response to request information;

FIG. 11 is a schematic view showing an example in which readout data is written based on received readout information;

FIG. 12 is a flowchart explanatory of a write process performed by the information processing apparatus;

FIG. 13 is a flowchart explanatory of a read process performed by the information processing apparatus; and

FIG. 14 is a schematic view showing another typical structure of the information processing apparatus.

### DETAILED DESCRIPTION OF THE PREFERRED EMBODIMENTS

Some preferred embodiments of the present disclosure (called the preferred embodiment hereunder) will now be described. The description will be given under the following headings:

1. Embodiment of the present disclosure (an example in which an address translation table is utilized, with network node addresses attached); and

2. Variations.

### 1. Preferred Embodiment

### [Typical Configuration of the Information Processing System 1]

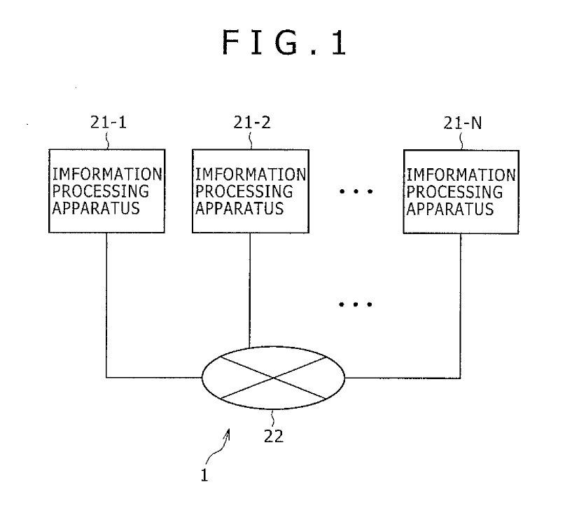

FIG. 1 shows a typical configuration of an information processing system 1 embodying the present disclosure.

The information processing system 1 is made up of information processing apparatuses 21-1 through 21-N that are interconnected via a network 22 such as the Internet.

The information processing apparatuses 21-1 through 21-N each possess a local memory typically composed of a hard click or the like for storing data and programs. Each local memory has a plurality of storage areas that may be utilized by each of the information processing apparatuses 21-1 through 21-N as a virtual storage area.

For example, a unique virtual address may be assigned to each of a plurality of storage areas in each of a plurality of local memories.

### [Typical Structure of the Information Processing Apparatus 21-n]

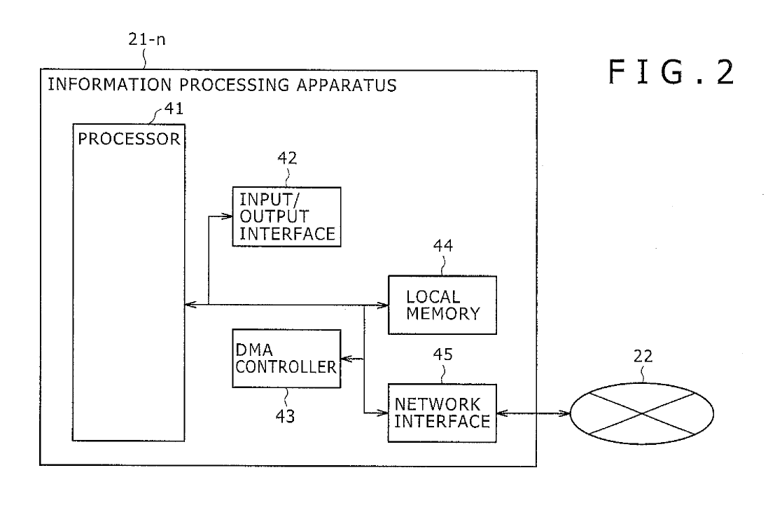

FIG. 2 shows a typical structure of the information processing apparatus 21-n.

The information processing apparatus 21-n may be a personal computer or the like connected to the network 22, for example. The information processing apparatus 21-n is typically made up of a processor 41, an input/output interface (IF) 42, a direct memory access (DMA) controller 43, a local memory 44, and a network interface (IF) 45.

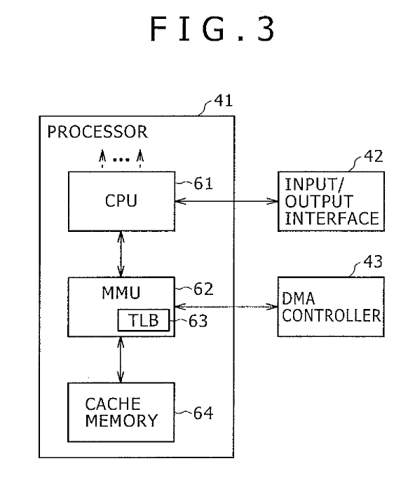

The processor 41, composed of a CPU (central processing unit) or the like, controls the components configured. Also, the processor 41 may perform suitable processes in response to operation signals coming from the input/out interface 42 for example. The processor 41 will be discussed later in detail with reference to FIG. 3.

The input/output interface 42 is connected to an operation portion (not shown) such as a mouse and a keyboard. The input/output interfaced 42 is supplied with operation signals from the operation portion being operated by a user, and forwards the supplied signals to the processor 41.

Under control of the processor 41, the DMA controller 43 sends data from the processor 41 to the local memory 44 for storage by DMA transfer. Also under control of the processor 41, the DMA controller 43 reads data from the local memory 44 and sends the retrieved data to the processor 41 by DMA transfer.

Furthermore, the DMA controller 43 transfers the data out of the processor 41 to the network interface 45 by DMA transfer under control of the processor 41. The DMA controller 43 also sends data from the network interface 45 to the processor 41 by DMA transfer.

The local memory 44 may be a hard disk, an EEPROM (electrically erasable and programmable read only memory), or a DRAM (dynamic random access memory), for example, storing data and the like sent from the DMA controller 43 by DMA transfer. The local memory 44 is made up of a plurality of storage areas each associated with a physical address representing the location of the storage area in question.

The network interface 45 transmits data coming from the DMA controller 43 to another information processing apparatus 21-p (p≠n) via the network 22. The network interface 45 also supplies the DMA controller 43 with the data transmitted from the other information processing apparatus 21-p over the network 22.

### [Typical Structure of the Processor 41]

FIG. 3 shows a typical detailed structure of the processor 41.

The processor 41 is made up of a CPU 61, a memory management unit (MMU) 62, a translation look-aside buffer (TLB) incorporated in the MMU 62, and a cache memory 64.

The CPU 61 controls the MMU 62, DMA controller 43, and other components. Also, the CPU 61 writes the programs held beforehand in the local memory 44 to the cache memory by way of the DMA controller 43 and MMU 62. Furthermore, by way of the MMU 62, the CPU 61 acquires programs from the cache memory 64 where they are being retained.

The CPU 61 carries out predetermined processes by executing the acquired programs. For example, the CPU 61 may supply the MMU 62 with a virtual address assigned to a virtual storage area so as to read the data corresponding to that virtual address from the cache memory 64 through the MMU 62. As will be explained later, the cache memory 64 retains predetermined data in association with a corresponding virtual address.

The CPU 61 then performs such processes as calculation and manipulation on the readout data. The CPU 61 writes the results of the processes to the cache memory 64 or local memory 44.

For example, if the data corresponding to the virtual address sent to the MMU 62 is not found in the cache memory 64, the CPU 61 may control the DMA controller 43 or the like to read the corresponding data from the local memory 44 or from the other information processing apparatus 21-p in which the data in question exists, and to feed the retrieved data to the MMU 62.

The CPU 61 may then control the MMU 62 to associate the data from the DMA controller 43 with the corresponding virtual address and feed the data to the cache memory 64 for storage. In this manner, the CPU 61 can obtain the data corresponding to the virtual address fed to the MMU 62, from the cache memory 64 by way of the MMU 62.

Using the incorporated TLB 62, the MMU 62 translates the virtual address coming from the CPU 61 into the corresponding physical address and network node address (both to be discussed later), or translates inversely the physical address and network node address associated with the data from the DMA controller 43 into the corresponding virtual address.

The TLB 63 holds in advance an address translation table containing a plurality of previously created entries 1 trough m.

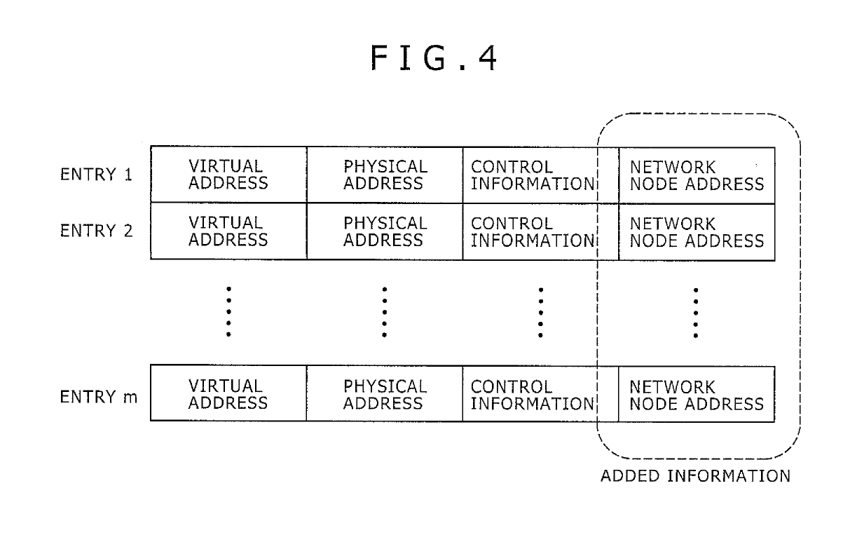

FIG. 4 shows an example of the TLB 63.

As shown in FIG. 4, the TLB 63 is furnished beforehand with an address translation table having a plurality of entries 1 through m each containing a virtual address assigned to a virtual storage area, a physical address corresponding to the virtual address and assigned to a storage area on the local memory 44, control information used for the control in translating the virtual address into the virtual address, and a network node address representing the location on the network of the local memory 44 (or the information processing apparatus 21-n holding the memory 44) retaining the storage area designated by the physical address.

The network node address may be formed by information that uniquely represents the information processing apparatus 21-n. For example, the network node address may be the IP (Internet Protocol) address or MAC (Media Access Control) address of the information processing apparatus 21-n. Alternatively, the network node address may be part or all of the domain information (e.g., part of the home page address or email address) denoting the location on the network of the information processing apparatus 21-n.

The MMU 62 reads and retains as needed a plurality of virtual addresses each associated with data held in the cache memory 64.

The MMU 62 determines whether each of the multiple virtual addresses it retains matches the virtual address coming from the CPU 61.

If it is determined that one of the retained multiple virtual addresses matches the virtual address coming from the CPU 61, the MMU 62 reads from the cache memory 64 the data associated with the matching virtual address, and feeds the retrieved data to the CPU 61.

If it is determined that none of the retained multiple virtual addresses matches the virtual address coming from the CPU 61, the MMU 62 translates the virtual address from the CPU 61 into the corresponding physical address and network node address based on the plurality of entries 1 through m held in the TLB 63.

The MMU 62 proceeds to supply the DMA controller 43 with the physical address and network node address acquired through address translation.

Using the TLB 63, the MMU 62 also translates inversely the physical address and network node address associated with the data from the DMA controller 43 into the corresponding virtual address. The MMU 62 feeds the virtual address acquired through inverse translation to the cache memory 64 for storage therein in association with the data from the DMA controller 43.

The cache memory 64 may be composed of a RAM (random access memory) or the like. As such the cache memory 64 accommodates the data which comes from the MMU 62 and which is associated with a virtual address.

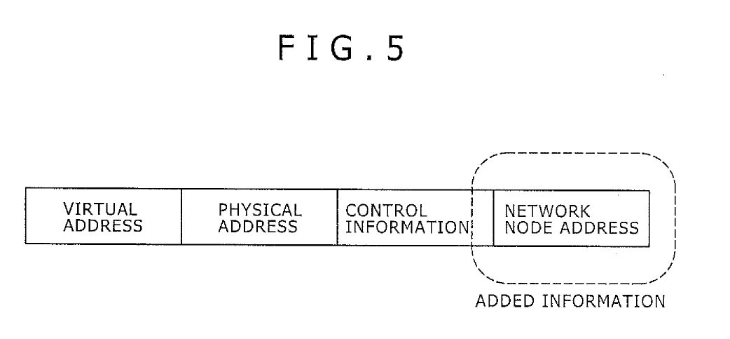

The preceding paragraphs explained that in the processor 41, the MMU 62 performs address translation using the address translation table such as one having a plurality of entries 1 through m as shown in FIG. 4. Alternatively, the MMU 62 may be an address translation register that carries out address translation using an address translation table containing only one entry as shown in FIG. 5.

In this case, the single entry indicated in FIG. 5 may be updated as needed under control of the OS or like programs causing the CPU 61 to perform relevant processes.

The MMU 62 may be constituted by either a single translation register or a plurality of address translation registers.

If the MMU 62 is composed of a plurality of address translation registers, the multiple address translation registers may either share the same address translation table or each utilize a different address translation table. In this case, the TLB 63 may be typically structured to hold a plurality of address translation tables for use by the MMU 62 composed of a plurality of address translation registers.

The processor 41 shown in FIG. 3 is substantially the same as an existing processor except that network node addresses are added to the address translation table held in the TLB 63.

That means the existing processor may be used unmodified as the processor 41 according to the present disclosure, since the address translation table held in the TLB 63 need only be replaced with an address translation, table supplemented by network node addresses. This makes it possible to reduce the manufacturing costs of the processor 41,

[Example in which Write Information is Transmitted]

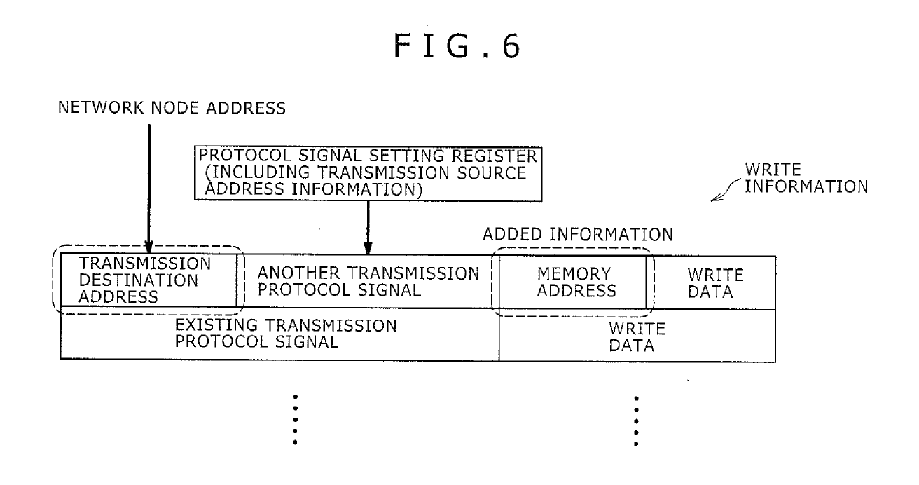

FIG. 6 is a schematic view showing an example of write information created when the information processing apparatus 21-a writes data to a storage area in the local memory 44b of another information processing apparatus 21-b.

Reference characters “a” and “b” each denote one of different integers ranging from 1 to N. In the ensuing description, the CPU 61 constituting part of the information processing apparatus 21-a will be referred to as the CPU 61a and the CPU 61 of the information processing apparatus 21-b as the CPU 61b for distinction purposes. The same holds for the other components of the information processing apparatus 21.

The CPU 61a of the information processing apparatus 21-a processes the data corresponding to a given virtual address and feeds the processed data to the MMU 62a together with the virtual address corresponding to the processed data.

Under control of the CPU 61a, the MMU 62a translates the virtual address coming from the CPU 61a into the corresponding network node address and physical address using the TLB 63a or the like. The MMU 62a sends the translated addresses to the DMA controller 43a along with the data from the CPU 61a.

In this case, it is assumed that the network node address acquired through address translation represents the location of the information processing apparatus 21-b on the network 22 and that the physical address obtained likewise denotes (i.e., designates) a corresponding one of a plurality of storage areas in the local memory 44b of the information processing apparatus 21-b.

The DMA controller 43a supplies the network interface 45a with the network node address and physical address of the information processing apparatus 21-b as well as data, the addresses and the data being fed from the MMU 62a.

The network interface 45a incorporates a protocol signal setting register (not shown) that holds in advance an existing transmission protocol signal including the existing Internet protocol or the like for use in communication, transmission source address information (e.g., network node address of the information processing apparatus 21-a), and another transmission protocol signal including a protocol different from the existing Internet protocol.

Under control of the DMA controller 43a, the network interface 45a reads the existing transmission protocol signal and the other transmission protocol signal from the internal protocol signal setting register.

The network interface 45a then constructs write information such as is shown in FIG. 6 including the retrieved existing transmission protocol signal and other transmission protocol signal, the transmission destination address composed of the network node address from the DMA controller 45a, write data supplied from the DMA controller 45a, and a memory address formed by the physical address from the DMA controller 45a and pointing to that storage area in the local memory 44b of the information processing apparatus 21-b to which the write data is to be written. The write information thus constructed is transmitted to the information processing apparatus 22-b over the network 22,

[Example in which Write Data is Written]

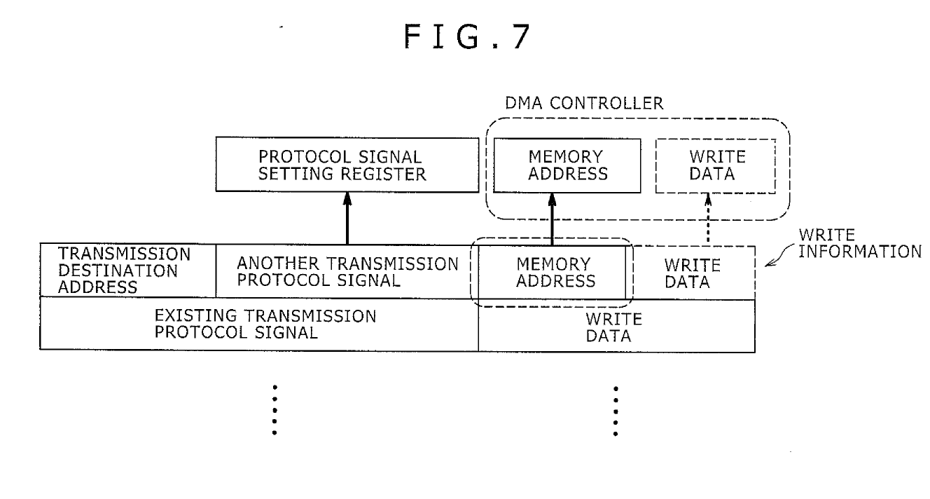

FIG. 7 shows an example in which write data included in write information sent from the information processing apparatus 21-a to the information processing apparatus 21-b is written to one of a plurality of storage areas in the local memory 44b based on the write information, the storage area to which to write the data being designated by the memory address included in the write information.

The network interface 45b of the information processing apparatus 21-b receives the other transmission protocol signal and the existing protocol signal as part of the write information such as is shown in FIG. 7 transmitted from the information processing apparatus 21-a over the network 22.

The network interface 45b proceeds to store the received other transmission protocol signal and existing transmission protocol signal into the internal protocol signal setting register. Also, based on the other transmission protocol signal and existing transmission protocol signal thus stored, the network interface 45b receives the memory address and write data included in the write information and feeds the received address and data to the DMA controller 43b.

The DMA controller 431 forwards the write data coming from the network interface 45b to the local memory 44b so that the data will be written to that storage area in the local memory 44b which is designated by the memory address supplied from the network interface 45b.

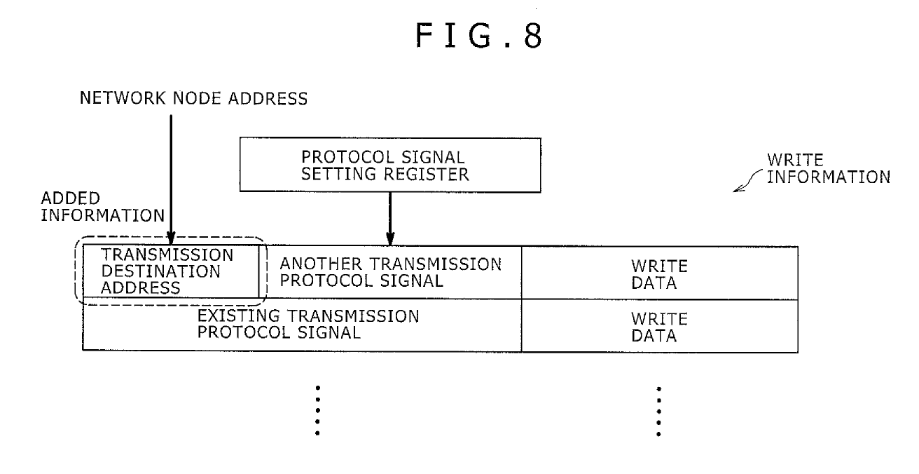

In the foregoing description, the information processing apparatus 21-a was shown creating and transmitting the write information such as is shown in FIG. 6 including the memory address designating the storage area to which write data is to be written. Alternatively, if the storage area to which the write data is to be written is previously known to the information processing apparatus 21-b, the information processing apparatus 21-a may create and transmit write information such as is indicated in FIG. 8 not including any memory address.

In this case, the write information can be created and transmitted more quickly because there is no need to per form the process of having the memory address included in the write information.

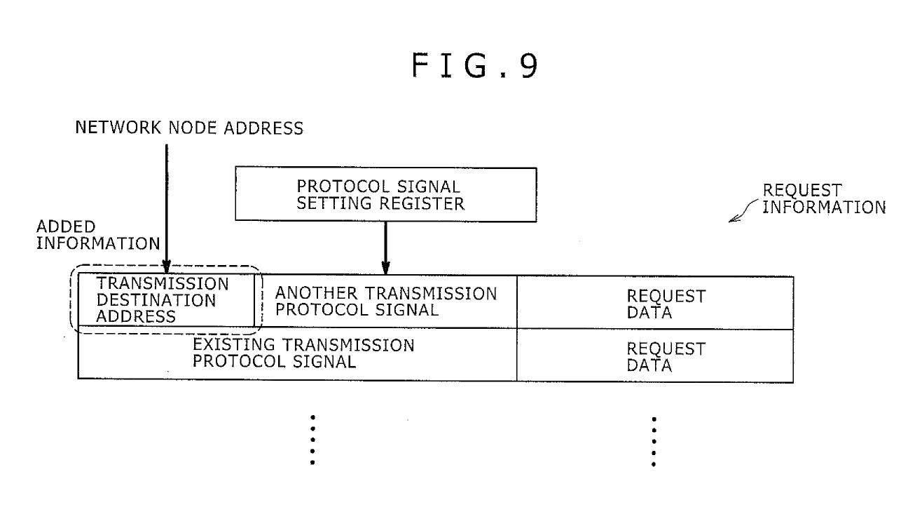

Explained below in reference to FIGS. 9 through 11 are examples in which the information processing apparatus 21-a reads relevant data from the information processing apparatus 21-b, i.e., the information processing apparatus 21-a requests transmission of the data of interest from the information processing apparatus 21-b and receives the data transmitted in response to the request.

[Example in which Request Information is Transmitted]

FIG. 9 shows an example of request information created by the information processing apparatus 21-a requesting the information processing apparatus 21-b to transmit the data of interest.

The CPU 61a of the information processing apparatus 21-a feeds a relevant virtual address to the MMU 62a when reading data from the virtual address in question in the virtual storage area.

Under control of the CPU 61a, the MMU 62a determines whether or not any one of a plurality of virtual addresses it retains (i.e., virtual addresses associated with the data held in the cache memory 64) matches the virtual address sent from the CPU 61a.

If it is determined that one of the multiple virtual addresses retained matches the virtual address coming from the CPU 61a, the MMU 62a reads from the cache memory 64a the data associated with the matching virtual address and feeds the retrieved data to the CPU 61a.

If it is determined that none of the multiple virtual addresses retained matches the virtual address sent from the CPU 61a, the MMU 62a translates the virtual address from the CPU 61a into the corresponding network node address and physical address through the use of the TLB 63a for example, and supplies the translated addresses to the DMA controller 43a.

Based on whether the network node address fed from the MMU 62a matches the previously retained network node address of the information processing apparatus 21-a, the DMA controller 43a determines whether the network node address fed from the MMU 62a turns out to be the network address of the information processing apparatus 21-a.

If it is determined that the network node address fed from the MMU 62a is the network address of the information processing apparatus 21-a, the DMA controller 43a sends the physical address coming from the MMU 62a to the local memory 44a so as to read data from one of a plurality of storage areas in the local memory 44a, the storage area from which to read the data being designated by the physical address.

The DMA controller 43a associates the retrieved data with the network node address and physical address fed from the MMU 62a and supplies the data to the MMU 62a.

In this case, the MMU 62a translates inversely the network node address and physical address associated with the data from the DMA controller 43a into the corresponding virtual address through the use of the TLB 63 for example. The MMU 62a proceeds to associate the data from the DMA controller 43a with the virtual address acquired through inverse translation and send the data to the cache memory 64 for storage therein.

If it is determined that the network node address fed from the MMU 62a is not the network address of the information processing apparatus 21-a, the DMA controller 43a supplies the network interface 45a with the network node address and physical address from the MMU 62a.

In this case, it is assumed that the network node address acquired through address translation represents the location of the information processing apparatus 21-b on the network 22 and that the physical address obtained likewise denotes a corresponding one of a plurality of storage areas in the local memory 44b of the information processing apparatus 21-b.

Under control of the DMA controller 43a, the network interface 45a reads the existing transmission protocol signal and other transmission protocol signal from the internal protocol signal setting register.

Also, the network interface 45a creates request data which includes the physical address sent from the DMA controller 45a and which is used to request data stored in one of a plurality of storage areas of the local memory 44b, the storage area from which to read the data being designated by the physical address from the DMA controller 45a.

Furthermore, the network interface 45a regards the network node address from the DMA controller 45a as the transmission destination address. The network interface 45a proceeds to create request information as shown in FIG. 9 composed of the retrieved existing transmission protocol signal and other transmission protocol signal, the transmission destination address, and the request data. The network interface 45a transmits the request information thus created to the information processing apparatus 21-b via the network,

[Example in which Readout Information is Transmitted]

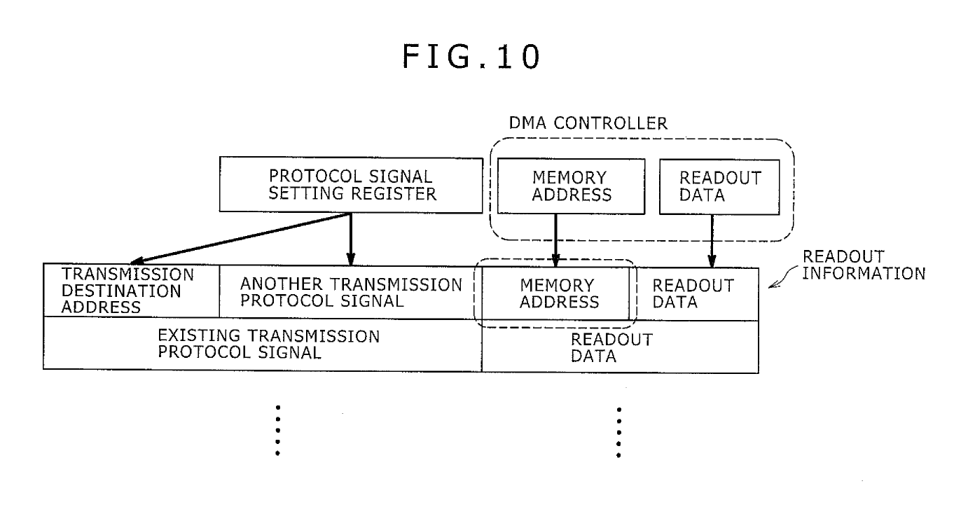

FIG. 10 shows an example in which the information processing apparatus 21-b transmits relevant data to the information processing apparatus 21-a based on the request information received from the latter apparatus 21-a.

The network interface 45b of the information processing apparatus 21-b receives the other transmission protocol signal and existing transmission protocol signal included in the request information supplied from the information processing apparatus 21-a via the network 22. The network interface 45a then feeds the received other transmission protocol signal and existing transmission protocol signal to the internal protocol signal setting register for storage therein.

Based on the other transmission protocol signal and existing transmission protocol signal written to the internal protocol signal setting register, the network interface 45b receives the request data included in the request information and feeds the received request data to the DMA controller 43b.

On the basis of the request data from the network interface 45b, the DMA controller 43b reads data from one of the storage areas in the local memory 44b, the storage area from which to read the data being designated by the physical address included in the request data. The DMA controller 43b supplies the network interface 45b with the retrieved data as readout data. Also, the DMA controller 43b supplies the network interface 45b with a memory address formed by the physical address (i.e., physical address included in the request data) designating the storage area from which the readout data was retrieved.

Using the internal protocol signal setting register, the network interface 45b regards the transmission destination address (i.e., network node address of the information processing apparatus 21-a) included in the request data as its transmission destination address.

The network interface 45b then creates readout information composed of the transmission destination address, the other transmission protocol signal and existing transmission protocol signal retained in the internal protocol signal setting register, and the readout data and memory address fed from the DMA controller 43b. The network interface 45b transmits the readout information thus created to the information processing apparatus 21-a via the network 22.

[Example in which Readout Information is Received and Readout Data is Stored]

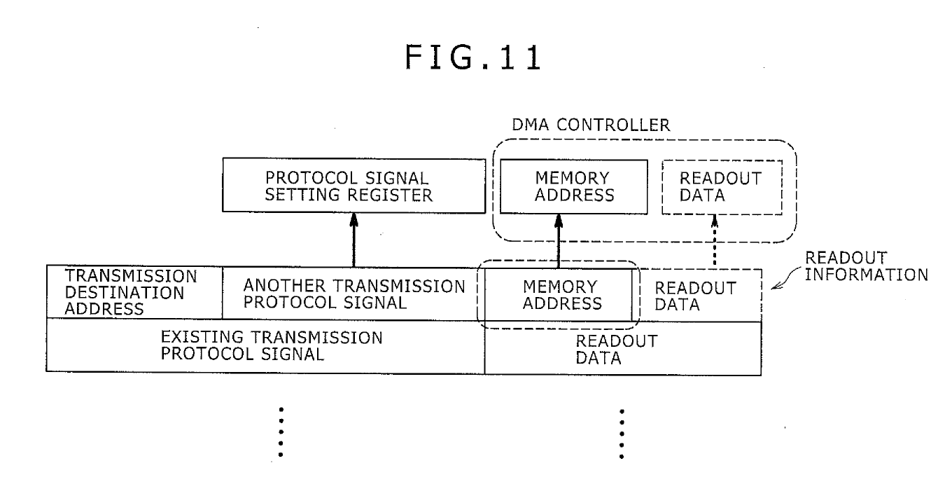

FIG. 11 shows an example in which the information processing apparatus 21-a receives the readout information transmitted from the information processing apparatus 21-b in response to the request information sent to the latter apparatus 21-b, the information processing apparatus 21-a further storing the readout data included in the received readout information.

The network interface 45a of the information processing apparatus 21-a receives the other transmission protocol signal and existing transmission protocol signal contained in the readout information fed from the information processing apparatus 21-b via the network 22. The network interface 45a proceeds to send the received other transmission protocol signal and existing transmission protocol signal to the internal protocol signal setting register for storage therein.

Based on the other transmission protocol signal and existing transmission protocol signal written to the protocol signal setting register, the network interface 45a receives the readout data and memory address contained in the readout information fed from the information processing apparatus 21-b via the network 22, and supplies the received readout data and memory address to the DMA controller 43a.

Also, the network interface 45a extracts the network node address of the transmission source (i.e., information processing apparatus 21-b) included in the other transmission protocol signal held in the protocol signal setting register and feeds the extracted network node address to the DMA controller 43a.

The DMA controller 43a supplies the MMU 62a of the processor 41a with the readout data from the network interface 45a in association with the memory address and network node address fed also from the network interface 45a.

In this case, the MMU 62a translates inversely the memory address and network node address associated with the readout data from the DMA controller 43a into the corresponding virtual address through the use of the TLB 63a.

The MMU 62a then associates the virtual address obtained through inverse translation with the readout data from the DMA controller 43a, before sending the virtual address to the cache memory 64a for storage therein.

### [Write Process Performed by the Information Processing Apparatus 21-a]

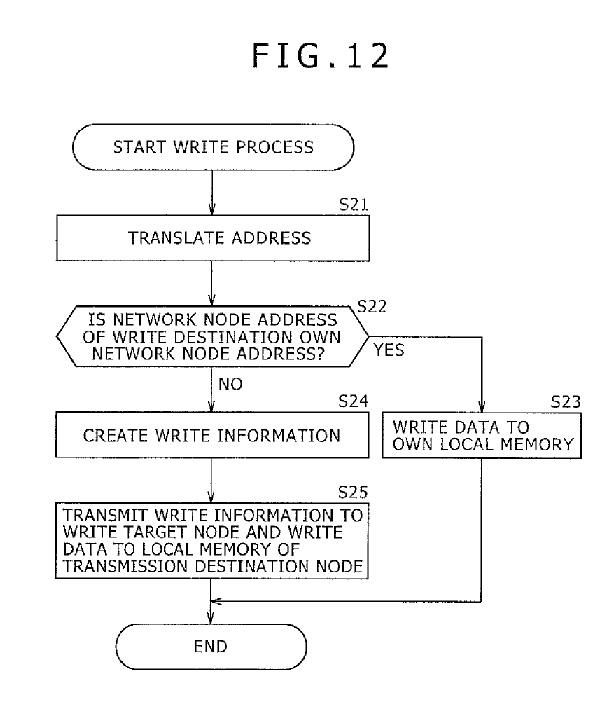

Explained below in reference to the flowchart of FIG. 12 is a typical write process performed by the information processing apparatus 21-a for writing data to the local memory 44a of the information processing apparatus 21-a or to the local memory 44b of the information processing apparatus 21-b.

The write process may be started in such a case as when the CPU 61a processes data at a given virtual address and controls the MMU 62a or the like to write the processed data to one of a plurality of storage areas in the local memory designated by the network node address corresponding to the virtual address, the storage area to which to write the data being designated by the physical address corresponding to the virtual address.

For example, the CPU 61a may feed the processed data to the MMU 62a together with the corresponding virtual address.

In step S21, the MMU 62a translates the virtual address coming from the CPU 61a into the corresponding physical address and network node address through the use of the internal TLB 63a or the like. The MMU 62a sends the physical address and network node address acquired through address translation to the DMA controller 43a along with the data fed from the CPU 61a.

In step S22, based on whether the network node address fed from the MMU 62a matches the previously retained network node address denoting the location of the information processing apparatus 21-a, the DMA controller 43a determines whether or not the network node address from the MMU 62a is the network node address representing the location of the information processing apparatus 21-a.

If in step S22 it is determined that the network node address fed from the MMU 62a is indeed the network node address representing the location of the information processing apparatus 21-a based on whether the network node address from the MMU 62a matches the previously retained network node address denoting the location of the information processing apparatus 21-a, then step S23 is reached.

In step S23, the DMA controller 43a feeds the data from the MMU 62a to the local memory 44a so that the data will be written to one of the storage areas in the local memory 44a, the storage area to which to write the data being designated by the physical address sent from the MMU 62a.

If in step S22 it is determined that the network node address fed from the MMU 62a is not the network node address representing the location of the information processing apparatus 21-a based on whether the network node address from the MMU 62a matches the previously retained network node address denoting the location of the information processing apparatus 21-a, then step S24 is reached.

In step S24, the DMA controller 43a supplies the network interface 45a with the network node address, physical address, and data fed from the MMU 62a.

On the basis of the network node address, physical address, and data fed from the DMA controller 43a, the network interface 45a creates write information such as is shown in FIG. 6.

In step S25, the network interface 45a transmits the write information thus created to the information processing apparatus 21-b via the network 22. In turn, the information processing apparatus 21-b writes the data based on the write information supplied from the network interface 45a via the network 22. This step completes the write process.

### [Read Process Performed by the Information Processing Apparatus 21-a]

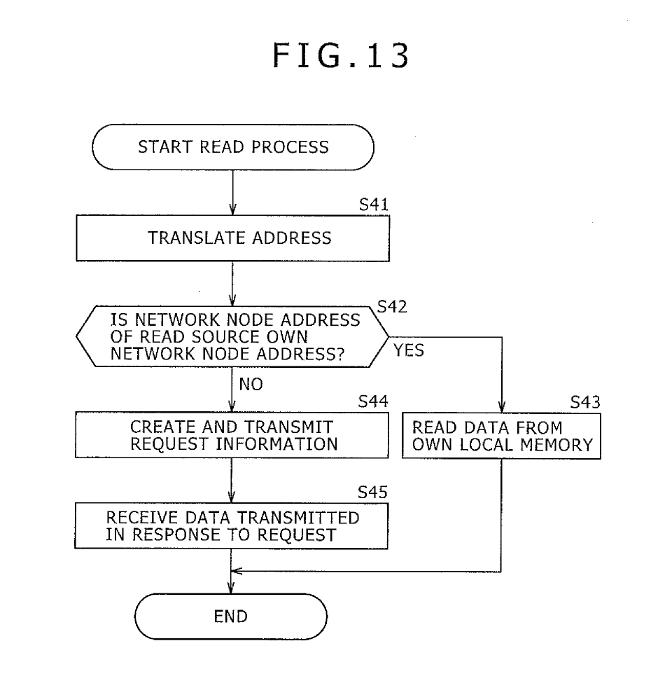

Explained below in reference to the flowchart of FIG. 13 is a typical read process performed by the information processing apparatus 21-a for reading data from the local memory 44a of the information processing apparatus 21-a or from the local memory 44b of the information processing apparatus 21-b.

The read process may be started in such a case as when the CPU 61a controls the MMU 62a or the like to read the data associated with a given virtual address from the virtual storage area.

For example, the CPU 61a sends to the MMU 62a the virtual address corresponding to the data targeted to be read out.

For the read process, it is assumed that the data needed by the CPU 61a of the information processing apparatus 21-a is not found in the cache memory 64a. If the data needed by the CPU 61a is retained in the cache memory 64a, then the CPU 61a reads the data from the cache memory 64a.

In step S41, the MMU 62a translates the virtual address fed from the CPU 61a into the corresponding physical address and network node address through the use of the internal TLB 63a or the like. The MMU 62a supplies the physical address and network node address acquired through address translation to the DMA controller 43a.

In step S42, based on whether the network node address fed from the MMU 62a matches the previously retained network node address denoting the location of the information processing apparatus 21-a, the DMA controller 43a determines whether or not the network node address from the MMU 62a is the network node address representing the location of the information processing apparatus 21-a.

If in step S42 it is determined that the network node address fed from the MMU 62a is indeed the network node address representing the location of the information processing apparatus 21-a based on whether the network node address from the MMU 62a matches the previously retained network node address denoting the location of the information processing apparatus 21-a, then step S43 is reached.

In step S43, the DMA controller 43a feeds the physical address from the MMU 62a to the local memory 44a so that the data will be read from one of the storage areas in the local memory 44a, the storage area from which to read the data being designated by the physical address sent from the MMU 62a.

The DMA controller 43a associates the readout data with the physical address and network node address fed from the MMU 62a, before sending the readout data to the MMU 62a. The MMU 62a translates inversely the physical address and network node address associated with the readout data from the DMA controller 43a into the corresponding virtual address.

The MMU 62a then associates the readout data from the DMA controller 43a with the virtual address obtained through inverse translation, before feeding the data to the cache memory 64 for storage therein. This allows the CPU 61a to perform relevant processes on the readout data placed in the cache memory 64.

If in step S42 it is determined that the network node address fed from the MMU 62a is not the network node address representing the location of the information processing apparatus 21-a based on whether the network node address from the MMU 62a matches the previously retained network node address denoting the location of the information processing apparatus 21-a, then the DMA controller 43a sends the network node address and physical address fed from the MMU 62a to the network interface 45a and transfers control to step S44.

In step S44, as explained above in reference to FIG. 9, the network interface 45a creates request information such as is shown in FIG. 9 based on the existing transmission protocol signal and other transmission protocol signal retained previously in the internal protocol signal setting register as well as on the network node address and physical address fed from the DMA controller 45a.

The network interface 45a transmits the request information thus created to the information processing apparatus 21-b via the network 22.

In step S45, the network interface 45a receives the other transmission protocol signal and existing transmission protocol signal included in the readout information fed from the information processing apparatus 21-b over the network 22 in response to the request information having been transmitted. The network interface 45a proceeds to teed the received other transmission protocol signal and existing transmission protocol signal to the internal protocol signal setting register for storage therein.

On the basis of the other transmission protocol signal and existing transmission protocol signal stored in the protocol signal setting register, the network interface 45a receives the readout data and memory address included in the readout information fed from the information processing apparatus 21-b via the network 22. The network interface 45a sends the received readout data and memory address to the DMA controller 43a.

Also, the network interface 45a extracts the network node address of the transmission source (i.e., information processing apparatus 21-b) included in the other transmission protocol signal held in the protocol signal setting register and feeds the extracted network node address to the DMA controller 43a.

The DMA controller 43a supplies the MMU 62a of the processor 41a with the readout data from the network interface 45a in association with the memory address and network node address fed also from the network interface 45a.

In this case, the MMU 62a translates inversely the memory address and network node address associated with the readout data from the DMA controller 43a into the corresponding virtual address through the use of the TLB 63a.

The MMU 62a then associates the virtual address obtained through inverse translation with the readout data from the DMA controller 43a, before sending the virtual address to the cache memory 64a for storage therein. This completes the read process.

In the write process, as explained earlier, the virtual address corresponding to the write data of interest is translated into the corresponding physical address and network node address through the use of the TLB 63 or the like holding beforehand an address translation table that contains entries associating virtual addresses with corresponding physical addresses and network node addresses. The data is then written to one of a plurality of storage areas in the local memory 44 held by the information processing apparatus 21-n corresponding to the network node address obtained through address translation, the storage area to which to write the data being designated by the physical address acquired also through address translation.

In the read process, as discussed above, the virtual address corresponding to the readout data of interest is translated into the corresponding physical address and network node address through the use of the TLB 63 or the like. The data is then read from one of a plurality of storage areas in the local memory 44 held by the information processing apparatus 21-n corresponding to the network node address obtained through address translation, the local address from which to read the data being designated by the physical address acquired also through address translation.

In the manner described above, the information processing apparatus 21-a may utilize not only the local memory 44a but also the local memory 44b of the information processing apparatus 21-b connected by way of the network 22 for example, as the recording medium for implementing the virtual storage area.

Thus according to the preferred embodiment discussed above, the information processing apparatus 21-a can freely access (i.e., read and write) the data stored in a plurality of local memories 44 attached to the information processing apparatuses 21-1 through 21-N on the network 22, regardless of whether the data to be read or written is stored in the local memory 44a.

### 2. Variations

In the foregoing description of the preferred embodiment, the storage areas of the local memory 44 held by each of the information processing apparatuses 21-1 through 21-N was shown utilized as the virtual storage area. Alternatively, servers or hard disks existing on the network 22 may also be used as virtual storage areas. That is, any recording media found on the network 22 may be utilized as virtual storage areas.

According to the preferred embodiment described above, the DMA controller 43 controls the writing and reading of data. Alternatively, the entity that controls data read and write operations is not limited to the DMA controller 43 or any other specific component.

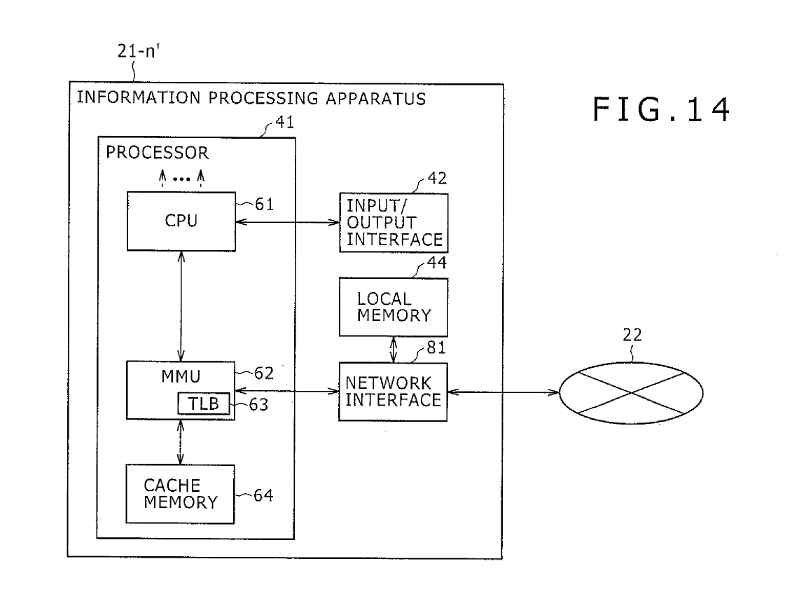

For example, in the case of an information processing apparatus 21-n′ shown in FIG. 14, a network interface 81 may take over from the DMA controller 43 in carrying out data read and write operations under control of the CPU 61.

According to the above-described preferred embodiment, the DMA controller 43a of the information processing apparatus 21-a determines whether the network node address fed from the MMU 62a is the network node address of the information processing apparatus 21-a. Alternatively, the entity that performs the determination is not limited to the DMA controller 43a or any other specific component.

For example, a determination function block for performing the determination in place of the DMA controller 43 may be provided inside the processor 41.

According to the above-described preferred embodiment, the TUB 63 of each information processing apparatus 21-n is furnished beforehand with the address translation table. Alternatively, the information processing apparatus 21-a may create an address translation table and send it to, say, the information processing apparatus 21-b via the network 22.

In this case, the information processing apparatus 21-b stores into the TLB 63b the address translation table sent from the information processing apparatus 21-a over the network 22.

in this example, the address translation table created by the information processing apparatus 21-a is transmitted via the network 22 to the information processing apparatus 21-b so that the address translation table created by the apparatus 21-a can be shared among the information processing apparatuses 21-1 through 21-N. If the address translation table is updated by the information processing apparatus 21-a, then the updated address translation table will be distributed to the information processing apparatuses involved.

According to the above-described preferred embodiment, the network interface 45a creates write information, request information, and readout information. Alternatively, a program executed by the CPU 61a of the processor 41a may be arranged to create write information, request information, and readout information and feed these kinds of information to the network interface 45a.

The series of processes described above may be executed either by hardware or by software. Where the software-based processing is to be carried out, the programs constituting the software may be either incorporated beforehand in the dedicated hardware of the computer to be used or installed upon use into a general-purpose personal computer or like equipment capable of executing diverse functions based on the installed programs.

If the above-mentioned series of processes such as those of creating and transmitting write information, request information, or readout information is desired to be performed solely by hardware, it may be necessary to constitute the existing transmission protocol signal and other transmission protocol signal to be included in the write information, request information, or readout information in accordance with a proprietary protocol that can be implemented only by the hardware involved.

If a suitable protocol for encrypting the write data, readout data, or request data for communication is adopted as the proprietary protocol for example, then virtual storage areas may be utilized more securely than if the existing protocol is adopted.

Alternatively, if the processes of creating and transmitting the write information, request information, or readout information are desired to be carried out by software alone, the programs making up the software may be implemented using the existing transmission protocol signal to be included in the write information, request information, or readout information. This will eliminate the need for preparing the proprietary protocol.

For example, the present disclosure may be applied to so-called cloud computing or like scheme allowing data and programs existing on the network to be shared by the participants in the scheme.

In this specification, the steps describing the series of processes discussed above represent not only the processes that are to be carried out in the depicted sequence (i.e., on a time series basis) but also processes that may be performed parallelly or individually and not necessarily chronologically.

It should be understood by those skilled in the art that various modifications, combinations, sub-combinations and alterations may occur depending on design requirements and other factors in so far as they are within the scope of the appended claims or the equivalents thereof.

The present disclosure contains subject matter related to that disclosed in Japanese Priority Patent Application JP 2010-161190 filed in the Japan Patent Office on Jul. 16, 2010, the entire content of which is hereby incorporated by reference.

What is claimed is:

1. An information processing apparatus connected to a network, said information processing apparatus comprising:
an address translation section configured such that when a virtual address assigned to a virtual storage area is held in an address translation module and associated therein with network node information designating the location of a storage portion connected to said network and with a physical address in said storage portion, said address translation section translates said virtual address into said network node information and said physical address based on said address translation module; and
an access communication section configured such that based on said network node information and said physical address acquired by said address translation section, said access communication section accesses one of a plurality of storage areas held by said storage portion connected to said network, the accessed storage area being designated by said physical address.

2. The information processing apparatus according to claim 1, further comprising a storage section having a plurality of storage areas;
wherein, if said network node information acquired by said address translation section represents the location of said storage section connected to said network, then said access communication section accesses one of said plurality of storage areas held by said storage section, the accessed storage area being designated by said physical address acquired by said address translation section; and
if said network node information acquired by said address translation section represents the location of an external storage portion different from said storage section on said network, then said access communication section accesses one of a plurality of storage areas held by said external storage portion, the accessed storage area being designated by said physical address acquired by said address translation section.

3. The information processing apparatus according to claim 2, wherein said address translation module holds a plurality of address translation tables each associating said virtual address with said network node information and said physical address; and
based on said plurality of address translation tables held by said address translation module, said address translation module translates said virtual address into the corresponding physical address and the corresponding network node information.

4. The information processing apparatus according to claim 2, wherein said address translation module holds an address translation table associating said virtual address with said network node information and said physical address; and
said information processing apparatus further includes an update section configured to update said address translation table held by said address translation module.

5. The information processing apparatus according to claim 1, wherein said network node information is a part or all of an Internet Protocol address known as an IP address, a Media Access Control address known as a MAC address, or domain information.

6. The information processing apparatus according to claim 1, wherein said address translation module holds an address translation table associating said virtual address with said network node information and said physical address; and
said information processing apparatus further includes a transmission section configured to transmit said address translation table held by said address translation module to another information processing apparatus connected to said network so as to share said address translation table with said other information processing apparatus.

7. An information processing method for use with and information processing apparatus connected to a network and including an address translation section and an access communication section, said information processing method comprising:
when a virtual address assigned to a virtual storage area is held in an address translation module and associated therein with network node information designating the location of a storage portion connected to said network and with a physical address in said storage portion, causing said address translation section to translate said virtual address into said network node information and said physical address based on said address translation module; and
based on said network node information and said physical address acquired by said address translation section, causing said access communication section to access one of a plurality of storage areas held by said storage portion connected to said network, the accessed storage area being designated by said physical address.

8. A program for causing a computer controlling an information processing apparatus connected to a network to function as an address translation section and an access communication section, said program comprising:
when a virtual address assigned to a virtual storage area is held in an address translation module and associated therein with network node information designating the location of a storage portion connected to said network and with a physical address in said storage portion, causing said address translation section to translate said virtual address into said network node information and said physical address based on said address translation module; and
based on said network node information and said physical address acquired by said address translation section, causing said access communication section to access one of a plurality of storage areas held by said storage portion connected to said network, the accessed storage area being designated by said physical address.
